(19) United States
(12) Patent Application Publication
(10) Pub. No.: US 2017/0218996 A1
(43) Pub. Date: Aug. 3, 2017

(54) FASTENING STRUCTURE AND FASTENING METHOD

(71) Applicant: NEWFREY LLC, New Britain, CT (US)

(72) Inventors: Atsushi TAKEDA, Utsunomiya-shi (JP); Kanji SAKODA, Utsunomiya-shi (JP); Tomoyoshi YAMADA, Utsunomiya-shi (JP)

(21) Appl. No.: 15/484,687

(22) Filed: Apr. 11, 2017

Related U.S. Application Data
(63) Continuation of application No. PCT/JP2015/075431, filed on Sep. 8, 2015.

(30) Foreign Application Priority Data
Oct. 31, 2014 (JP) 2014-222595

(51) Int. Cl. F16B 19/10; F16B 37/00; B21J 15/04; F16B 5/04

(52) U.S. Cl. CPC F16B 19/1054; F16B 5/04; F16B 37/00; B21J 15/043

(57) ABSTRACT

A fastening structure includes a blind rivet and a nut. The blind rivet includes a rivet body having a hollow sleeve, a rivet head at the end of the sleeve and a through-hole; and a mandrel having an elongated stem and a mandrel head. The nut is positioned around the sleeve side end of the rivet body and the mandrel head and abuts one of the workpieces. The end portion of the sleeve is enlarged by the mandrel head and is embedded in the internal screw threads of the nut. The workpieces are thus fastened between the nut and the rivet head.

### CROSS-REFERENCE TO RELATED APPLICATIONS

This application is a continuation of PCT Application No. PCT/JP2015/75431, filed on Sep. 8, 2015 which claims priority from Japanese Patent Application No. 2014-222595, filed on Oct. 31, 2014, the entire disclosure of which is incorporated herein by reference.

### BACKGROUND OF THE PRESENT INVENTION

The present invention pertains to a fastening structure. In particular, it pertains to a fastening structure and a fastening method which includes a blind rivet that can fasten with a stabilized fastening force.

Blind rivets provided with a hollow metal rivet body including a sleeve and a rivet head on one end of the sleeve, and a metal mandrel with a shaft that extends through and projects out from a through-hole in the rivet body, are well-known. Blind rivets have the advantage that multiple workpieces can be joined working from one side only.

The rivet body of a blind rivet has a rivet head formed on one end; a tubular hollow sleeve extends from the rivet head. The mandrel of the blind rivet has a head on one end, which has a diameter larger than the inner diameter of the sleeve, and a shaft which passes through the rivet body. The mandrel is inserted into the rivet body so that the head of the mandrel is placed contiguously to one end of the sleeve on the side opposite the rivet head, and the shaft of the mandrel projects out from the rivet head. Thus, the rivet body and the mandrel can be assembled together as the blind rivet.

The assembled blind rivet is inserted into the hole of a workpiece, such as a panel or the like, with the head of the mandrel going first; the rivet head is made to abut the periphery of the hole of the workpiece. The rivet head is held with a fastening tool, and the user pulls firmly from the rivet head side while gripping the shaft of the mandrel. When this done, one end of the sleeve of the rivet body undergoes deformation by means of the mandrel head so as to expand in diameter, and the mandrel breaks at a breakable portion of the shaft; the workpiece is thus fastened between the rivet head and the end of the sleeve, which has expanded in diameter.

Because existing blind rivets break the shaft of the mandrel at a narrow breakable portion, a fastening tool is needed, and the workpiece can undergo deformation if the load is not uniform.

Patent Reference 1 discloses a method for securing and attaching multiple components by using a blind rivet including a tubular member (a rivet body) which has a head portion on a base end and a shaft-shaped component (mandrel) inserted therein. By means of pulling the shaft-shaped component out in the direction of the base end, the tip of the tubular member is expanded in diameter. In addition to placing holes in multiple components, for inserting the tubular member, the hole of one component is corrugated, and the corrugations extend roughly in the circumferential direction. The tip of the tubular member expands in diameter in the hole by means of the expanded portion (the head) of the shaft-shaped component and is attached and secured by wedging into the corrugations.

In Patent Reference 1, the tubular member of the rivet opens and enlarges inside the hole of a component and wedges into the corrugations; as a result, a gap is opened between the hole and the tubular member, which the tubular member fills. For this reason, it is not necessary to form the hole to precise dimensions. Also, the surface of the hole has corrugations; because the tubular member opens and enlarges in the hole of the component and wedges into the corrugations, a strong attaching and securing force is obtained.

However, a disadvantage of Patent Reference 1 is that it takes time and effort to machine the workpiece to be attached, since corrugations must be formed in the holes of the workpieces. The tip of the tubular member is expanded in diameter by means of the enlarged portion of the shaft-shaped component when the shaft-shaped component is pulled out; if the enlarged portion does not go into the tip of the tubular member sufficiently, the diameter of the tubular member cannot be expanded adequately.

Another problem is that when a shearing-off portion is provided on the shaft-shaped component, the breaking load of the tensile force needed to break it varies greatly; that is, the fastening force is not stabilized.

Patent Reference 2 discloses a mechanism for joining a connector secured to the housing of an electronic device, to a connector on the cable side, in which a spacer component inserted in the housing side connector is made in the form of a blind rivet. The spacer has a standoff component which expands when inserted in a thread hole used to secure the housing side connector, and a female thread which is used for attaching and securing, which corresponds to the thread on the cable side connector. An extracting tool is inserted in the spacer, and after the spacer has been inserted in the thread hole of the connector, the extracting tool is pulled out. The expanded portion of the tip of the extracting tool passes through the through-hole of the spacer while pushing on and widening the hole, and the standoff component is made to expand. The expanded standoff component is tightly attached in the thread hole of the connector, joining the connector and spacer.

In Patent Reference 2, it is not necessary to rotate the screw when attaching the connector; as a result, the connector can be attached rapidly. If the head of the spacer has a hexagonal shape, for example, the spacer can be removed during maintenance by rotating it.

However, a disadvantage of Patent Reference 2 is that time and labor are needed to form a thread hole in the connector. As shown in FIG. 1 of Patent Reference 2, the expanded portion of the tip of the extracting tool passes through the through-hole of the spacer while pushing on and widening the hole. The standoff component of the spacer is attached by being tightly secured to the thread hole of the connector. However, if the standoff component of the spacer is stretched when the expanded portion passes through and is made longer in the axial direction of the shaft, a fastening force (shaft force) for compressing the workpiece in the axial direction cannot be obtained.

In summary, in References 1 and 2, workpieces can be fastened rapidly with a blind rivet. However, in Reference 1, a disadvantage is that the fastening force is not stabilized; that is, the fastening force varies, because the load on the mandrel is not stabilized during breaking. A further disadvantage is that a fastening force cannot be obtained if the expansion of a component is not adequate. In Patent Reference 2, a disadvantage is that an adequate fastening force cannot be obtained if the standoff component of the spacer is stretched.

For these reasons, a blind rivet is sought which can fasten workpieces with a stabilized fastening force, as is a fastening structure that includes such a blind rivet.

### PRIOR ART DOCUMENTS

Patent Reference 1: Unexamined Patent Publication 51-22963

Patent Reference 2: Unexamined Patent Publication 2000-21515

### SUMMARY OF THE PRESENT INVENTION

Accordingly, an object of the present invention is to offer a fastening structure and a fastening method which include a blind rivet that achieves a stabilized fastening force.

In order to attain this object, the fastening structure of the present invention is provided with a blind rivet and a nut-shaped component. The rivet body and the mandrel are assembled, and the blind rivet is inserted in the attaching hole of a workpiece, with the head of the mandrel going first. The nut-shaped component is put in place around the end of the sleeve of the rivet and the head of the mandrel which comes out from the opposite side of the attaching hole. By pulling out the shaft of the mandrel, the diameter of the end of the sleeve is expanded into female threads of the nut-shaped component. The workpiece is thus fastened between a flange of the rivet body and the nut-shaped component, which has engaged with the end of the sleeve.

A first embodiment of the present invention is a fastening structure provided with a blind rivet and a nut-shaped component, for fastening multiple workpieces that have attaching holes, which is characterized by the fact that the blind rivet includes a rivet body which has a hollow sleeve and a rivet head formed on one end of the sleeve, and is formed with a through-hole extending from the sleeve side end to the rivet head side end; a mandrel having a long, narrow shaft that is longer than the rivet body and having an outer diameter smaller than the inner diameter of the sleeve, and a mandrel head having an outer diameter larger than the inner diameter of the sleeve, but smaller than the outer diameter of the sleeve; and in which the mandrel head is placed contiguously to the sleeve side end of the rivet body, the shaft of the mandrel passing through the through-hole of the rivet body and projecting from the rivet head side end; wherein the inner diameter of the hole of the nut-shaped component is larger than the outer diameter of the sleeve of the rivet body; and wherein the nut-shaped component is placed on the outer periphery of the sleeve side end of the sleeve of the rivet body and the mandrel head.

If a blind rivet that includes a rivet body and a mandrel is used with a nut-shaped component that is formed with a female thread or a circumferential groove, the diameter of the sleeve is expanded, and the sleeve engages in the female thread or circumferential groove; it is thus possible to obtain a fastening structure in which a workpiece can be fastened with a stabilized fastening force.

It is desirable that the rivet head have a large outer diameter flange contiguous to the sleeve and a polygonal portion formed on the end, on the side opposite to the sleeve, contiguous to the flange.

If the flange has a large diameter, the workpiece can be pressed down over a wide area. By forming a polygonal portion, the fastened blind rivet and nut-shaped component can be removed with a wrench.

It is desirable that the flange of the rivet body abut a surface of the workpiece, and that the nut-shaped component be placed so that it abuts a different surface of the workpiece.

If the flange and the nut-shaped component abut the surfaces of the workpiece, the workpiece can be clamped over a wide area, and held by means of the flange and the nut-shaped component.

It is desirable that the end of the sleeve expand in diameter by being compressed by the mandrel head, and that the end of the sleeve which has expanded in diameter engage in the female thread of the nut-shaped component, so that the workpiece is fastened between the nut-shaped component and the flange.

If the diameter of the end of the sleeve is expanded in diameter by the mandrel head, the end of the sleeve engages deep into the thread or circumferential groove of the nut-shaped component, and the workpiece can be held by the nut-shaped component and the flange.

It is desirable that the mandrel break at a breakable portion, and that the part of the mandrel from the breakable portion to the mandrel head remain in the sleeve.

If the part of the mandrel from the breakable portion to the mandrel head remains in the sleeve, it is possible for the end of the sleeve to retain the expanded diameter shape caused by the mandrel head, and the workpiece can be held in a stabilized fashion.

It is desirable that the mandrel head be pulled back into the end of the sleeve, so that the end of the sleeve is expanded in diameter.

If the mandrel head is pulled back into the sleeve, the end of the sleeve is further expanded in diameter, and the end of the sleeve engages even more forcefully in the female thread or the circumferential groove; the workpiece is held between the nut-shaped component and the flange.

It is desirable that the sleeve be compressed in the central axis direction of the blind rivet.

If the sleeve is compressed in the center axis direction of the blind rivet, the workpiece can be held with a strong fastening force.

A second embodiment of the present invention is a fastening structure in which multiple workpieces with holes are fastened by a blind rivet and nut, characterized by the fact that the blind rivet includes a rivet body which has a hollow sleeve and a rivet head formed on one end of the sleeve, and a through-hole extending from the sleeve side end to the rivet head side; a mandrel having a shaft which breaks at a breakable portion, and having a mandrel head on one end; in which a nut is placed on the outer periphery of the sleeve side end of the sleeve of the rivet body and the mandrel head; in which the flange of the rivet body abuts one surface of one of the workpieces, and the nut abuts another surface of the other workpiece; in which the end of the sleeve is compressed and expanded in diameter by the mandrel head when the mandrel head is pulled back into the end of the sleeve and engages in the female thread of the nut. The workpieces are thus fastened between the nut and the flange.

A third embodiment of the present invention is a method for fastening multiple workpieces with holes by a blind rivet and a nut, characterized by the fact that the method is provided with a step in which one uses a rivet body which has a hollow sleeve, a flange at one end of the sleeve, and a rivet head contiguous to the flange, and which is formed with a through-hole; a mandrel which has a long, narrow shaft that is longer than the sleeve, having an outer diameter smaller than the inner diameter of the sleeve, and a mandrel head that is larger than the inner diameter of the sleeve but smaller than the outer diameter of the sleeve; and a nut having an inner diameter larger than the outer diameter of the sleeve of the rivet body. The blind rivet is made from the assembled rivet body and mandrel so that the mandrel head is contiguous to the sleeve side end of the rivet body, and the shaft of the mandrel passes through the through-hole of the rivet body and projects from the rivet head side end. The blind rivet is inserted into the attaching holes of one or more workpieces with the mandrel head going first, the flange of the rivet body is made to abut the workpiece; the nut is placed on the outer periphery of the mandrel head and the end of the sleeve of the rivet body so that the surface of the nut abuts around the attaching hole of the workpiece. When the mandrel head is pulled out from the rivet head side, while supporting the rivet head, the end of the sleeve is compressed by means of the mandrel head, expanding in diameter; the outer periphery of the end of the sleeve engages in the female thread or circumferential groove of the nut, and the one or more workpieces are fastened between the nut which is engaged in the expanded diameter end of the sleeve and the flange.

The present invention accordingly offers a fastening structure and a fastening method which includes a blind rivet that provides a stabilized fastening force.

### BRIEF DESCRIPTION OF THE DRAWINGS

FIG. 1 is a front elevational view of an embodiment of the blind rivet of the present invention

FIG. 2 is a left side elevational view of the blind rivet in FIG. 1.

FIG. 3 is a right side elevational view of the blind rivet in FIG. 1.

FIG. 4 is a cross-sectional view of the blind rivet in FIG. 1, along line A-A in FIG. 2.

FIG. 5 is a perspective view of the nut and the blind rivet in FIG. 1, assembled and put in place in the attaching holes of two workpieces.

FIG. 6 is a front elevational view of a portion of what is shown in FIG. 5, in cross-section.

FIG. 7 is an enlarged cross-sectional detail view of the step of a method in which the assembled blind rivet and nut of FIG. 5 are put in place in the attaching hole of a workpiece.

FIG. 8 is a cross-sectional view, similar to that of FIG. 7, which shows an intermediate step in a method of fastening a workpiece by means of the blind rivet and nut of FIG. 5.

FIG. 9 is a cross-sectional view similar to that of FIG. 8, which shows another intermediate step in fastening a workpiece by means of the blind rivet and nut of FIG. 5.

FIG. 10 is a cross-sectional view similar to that of FIG. 9, which shows a final step in which the workpiece has been fastened by means of the blind rivet and nut of FIG. 5.

FIG. 11 is a diagram showing an example of measuring the relationship between time and force when fastening the blind rivet and nut of FIG. 5.

### DETAILED DESCRIPTION OF THE PREFERRED EMBODIMENTS

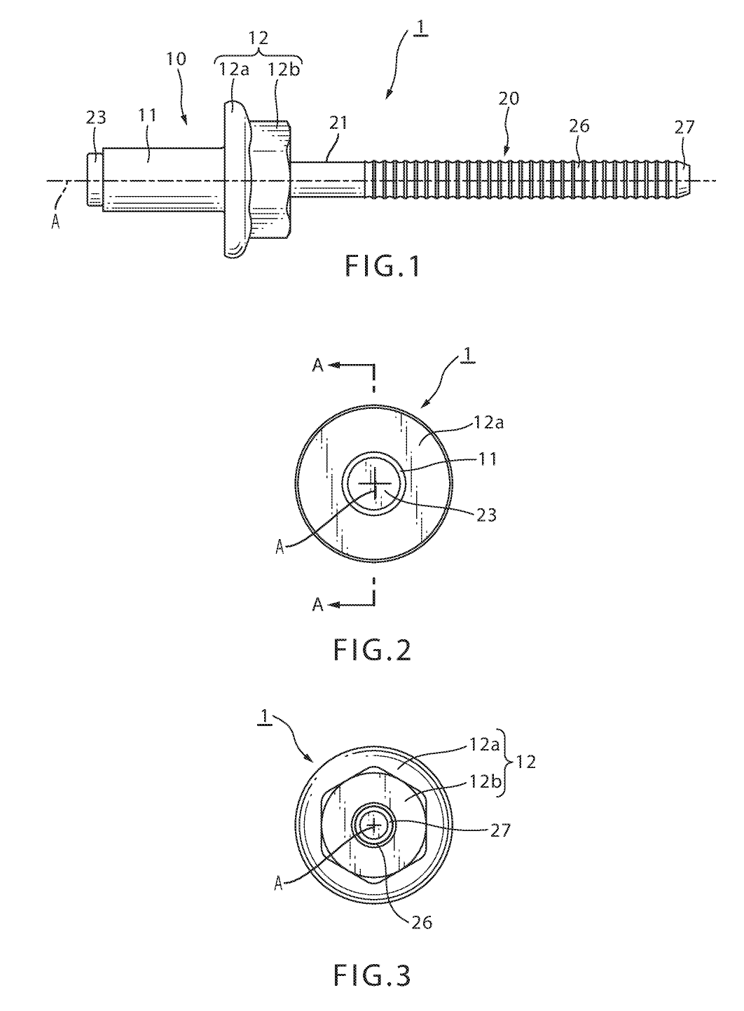

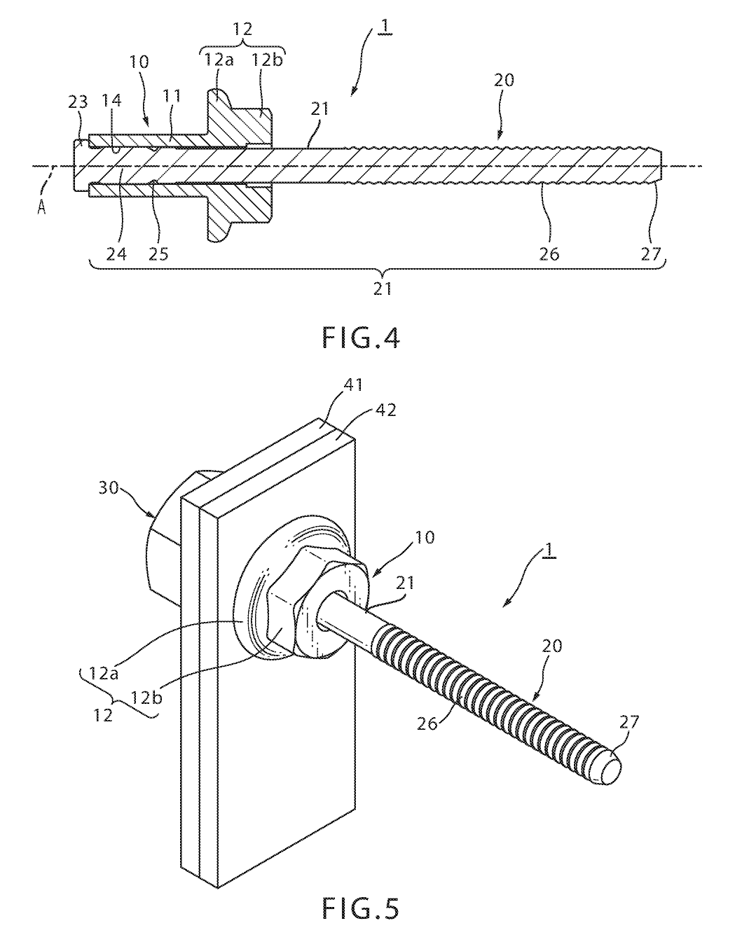

Next, a blind rivet subassembly 1 according to an embodiment of the present invention will be explained by referring to the Drawings. FIG. 1 is a front elevational view of blind rivet subassembly 1 of the present invention; FIG. 2 is a left side view; and FIG. 3 is a right side view. FIG. 4 is a cross-sectional view of the blind rivet 1 along line A-A of FIG. 2.

Blind rivet subassembly 1 is provided with a rivet body 10 and a mandrel 20.

Rivet body 10 includes a hollow tubular sleeve 11 and a rivet head 12 which is formed on one end of sleeve 11, having a larger diameter than sleeve 11. Rivet head 12 has a flange 12a and a polygonal portion 12b which is contiguous to flange 12a, and is formed on an end of the rivet body on the opposite side of the flange from the sleeve.

The outer diameter of flange 12a is larger than the outer diameter of sleeve 11 so that it abuts the surface of a workpiece 42 over a wide area (FIG. 5). Polygonal portion 12b is formed on the end of rivet body 10 and has a polygonal cross-section so that it can be rotated with a wrench, or the like.

Although rivet head 12 is shown with both a flange 12a and a polygonal portion 12b, rivet head 12 may be formed with only flange 12a, without the polygonal portion 12b. Also, flange 12a and polygonal portion 12b may be made as one part. In addition, polygonal portion 12b may include a polygonal hole formed in the flange 12a, for inserting a tool such as a wrench, or the like.

As shown in FIG. 4, rivet 10 has a through-hole 14 coaxial with the sleeve 11 along an axis A and which extends between a rivet head 12 side end and a sleeve 11 side end. Although through-hole 14 is of such a size to allow a shaft 21 of mandrel 20 to be inserted, it is smaller than the outer diameter of a mandrel head 23. Thus mandrel head 23 abuts and is stopped at the sleeve 11 side end of rivet body 10. The outer diameter of sleeve 11 is preferably equal to or larger than the outer diameter of mandrel head 23.

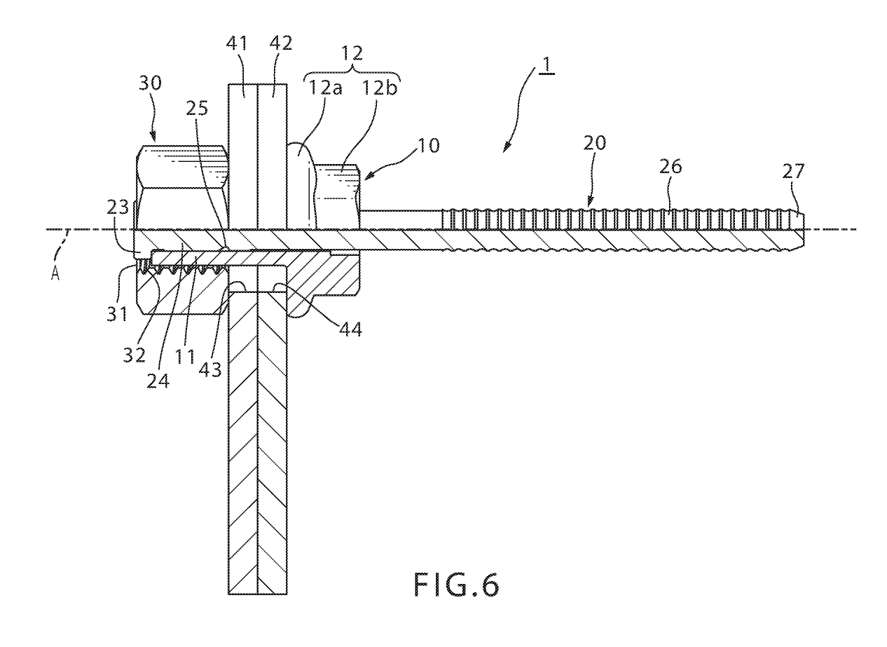

As shown in FIG. 6, the outer diameter of sleeve 11 is smaller than the respective inner diameters of attaching holes 43, 44 of workpieces 41, 42, and thus sleeve 11 can pass through attaching holes 43, 44.

Rivet body 10 may be made from a material that is softer than mandrel 20, for example, aluminum, an aluminum alloy, or the like. On the other hand, rivet body 10 may be made from the same or similar steel as mandrel 20.

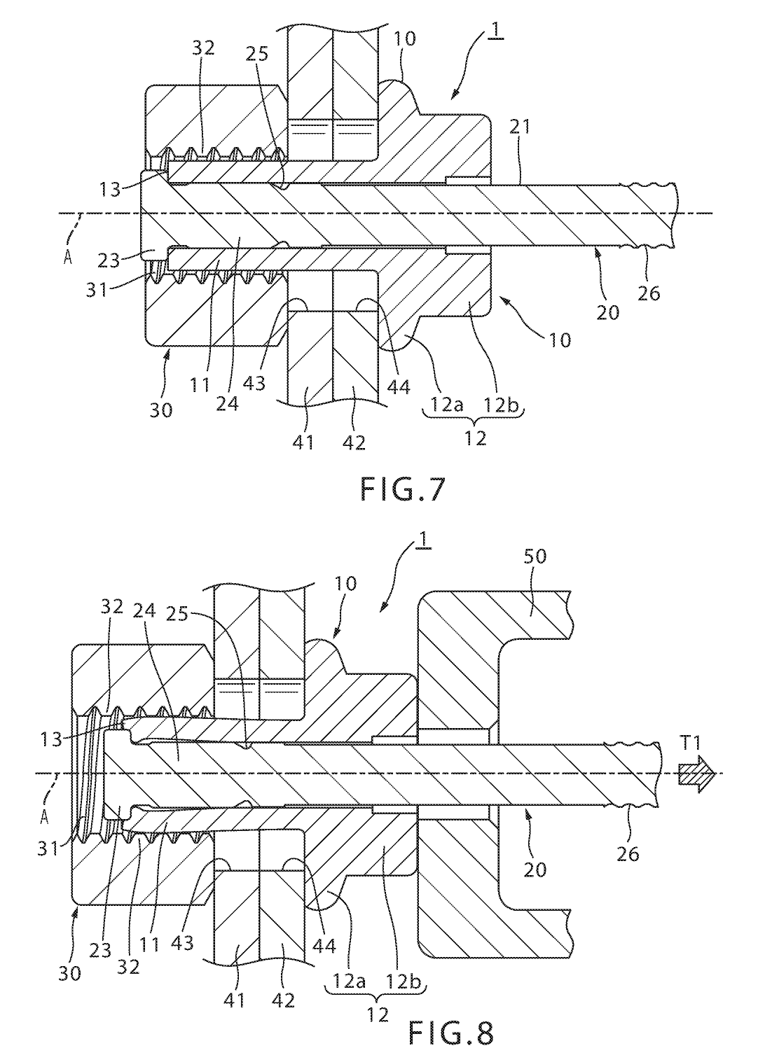

As shown in FIGS. 4 and 7, mandrel 20 is provided with an elongated narrow shaft 21; the mandrel head 23 is disposed at one end of shaft 21. The outer diameter of mandrel head 23 is larger than the inner diameter of through-hole 14 of rivet body 10 and smaller than the outer diameter of sleeve 11. The outer diameter of mandrel head 23 is smaller than the inner diameters of attaching holes 43, 44, respectively, of workpieces 41, 42 (FIG. 7), and can pass through attaching holes 43, 44. Shaft 21 is cylindrical and has an outer diameter equal to or smaller than the inner diameter of through-hole 14 of rivet body 10 and can be inserted in through-hole 14. Shaft 21 is longer than through-hole 14 of rivet body 10; when shaft 21 of mandrel 20 is inserted in through-hole 14 of rivet body 10, a tip 27 of shaft 21 projects from the of rivet head 12 side end of rivet body 10.

Still referring to FIGS. 4 and 7, shaft 21 of mandrel 20 includes, moving left to right from the mandrel head 23 side, columnar portion 24, breakable portion 25, grip 26 and tip 27. The columnar-shaped columnar portion 24 is contiguous to mandrel head 23. The outer diameter of columnar portion 24 is approximately equal to the inner diameter of sleeve 11; when mandrel 20 is attached to rivet body 10, mandrel 20 cannot slip from rivet body 10. Breakable portion 25 is contiguous to columnar portion 24 and has an outer diameter smaller than columnar portion 24. When the blind rivet is assembled, breakable portion 25 is disposed within through-hole 14 of rivet body 10. Breakable portion 25 is the part that breaks when the shaft 21 of mandrel 20 is pulled out using a fastening tool (not shown) such that a certain tensile force on the shaft 21 is exceeded.

In front of (axially to the right of, as seen in FIG. 4) breakable portion 25, shaft 21 becomes somewhat narrower than columnar portion 24. Farther forward (to the right), it can be seen that grip 26 has an outer diameter larger than breakable portion 25. Multiple locking grooves are formed on grip 26 so that when gripped by a gripping component of the fastening tool, the grip does not slip. The forward portion of tip 27 of shaft 21 narrows, so that it is narrow enough to be easily inserted into the fastening tool. Mandrel 20 is made from steel, or the like.

Mandrel 20 is inserted in through-hole 14 of rivet body 10 from the sleeve side end of rivet body 10, until mandrel head 23 abuts the sleeve side end of rivet body 10.

Next will be described the assembly of a nut 30 with blind rivet 1, and the emplacement of the blind rivet subassembly 1 in the attaching hole(s) of one or more workpieces. FIG. 5 is a perspective view of one embodiment of blind rivet subassembly 1 and nut 30 of the present invention, assembled, and inserted in attaching holes 43, 44, respectively, of workpieces 41, 42; this shows the step before fastening is carried out. FIG. 6 is a front elevational view of a portion of FIG. 5, in cross-section.

The outer diameter of the cross-section of nut 30 is polygonal, and a thread hole 31 having an inner surface is formed along its center axis A concentrically around both the sleeve side end of the sleeve 11 and the mandrel head 23. A set of female threads (or a set of circumferential grooves) 32 is formed in thread hole 31. Nut 30 is placed against workpiece 41, and is positioned and held so that thread hole 31 of nut 30 is axially aligned with attaching hole 43 of workpiece 41. Nut 30 is held by a holding component which is not shown in the Drawings.

As shown in FIG. 6, this embodiment of the present invention uses a nut or nut-shaped component 30; however, instead of nut 30, a nut-shaped component, which has parallel internal circumferential grooves formed in the circumferential direction, may also be used instead of a female thread 32 in the hole.

Still referring to FIG. 6, the inner diameter of the screw thread of female thread 32 of nut 30 is slightly larger than the outer diameter of sleeve 11, and sleeve 11 can be inserted into thread hole 31, since a slight radial gap may be created between sleeve 11 and the screw thread.

Blind rivet assembly 1, including the assembled rivet body 10 and mandrel 20, is inserted right to left in FIG. 6 into respective attaching holes 43, 44 of workpieces 41, 42, and into thread hole 31 of nut 30, with mandrel head 23 going first. This causes sleeve 11 of rivet body 10 also to enter attaching holes 43, 44 of workpieces 41, 42, and to enter thread hole 31 of nut 30, until flange 12a abuts the surface of workpiece 42 and is stopped.

The operation of fastening workpieces 41, 42 with the blind rivet subassembly 1 and nut 30 of the present invention will be explained by referring to FIGS. 7-10. FIG. 7 is a cross-sectional diagram which shows the appearance when the blind rivet subassembly 1 of FIG. 1 has been emplaced in attaching holes 43, 44 of workpieces 41, 42, and in nut 30.

Workpieces 41 and 42 are overlapped so that attaching hole 43 of workpiece 41 is axially aligned with that of attaching hole 44 of workpiece 42. Nut 30 is positioned on workpiece 41 so that thread hole 31 of nut 30 is axially aligned with attaching holes 43, 44. Nut 30 is held by a holding component (not shown).

If nut 30 is not held by a holding component, it may be secured in advance by joining and attaching it to workpiece 41.

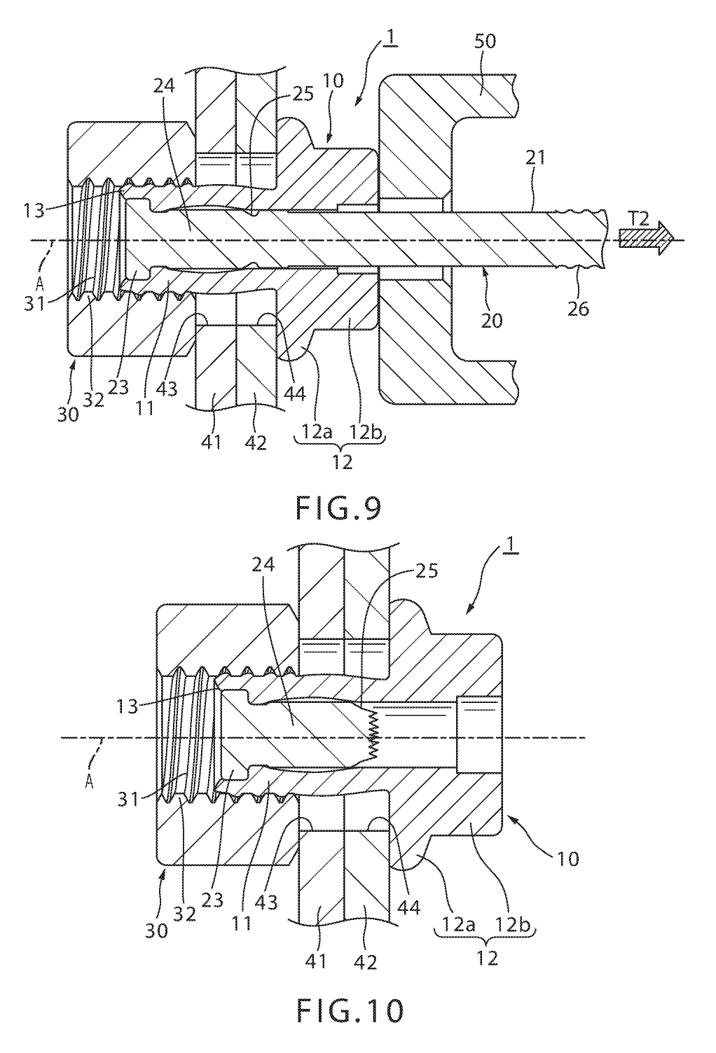

The blind rivet subassembly 1 of FIG. 1, with the assembled rivet body 10 and mandrel 20, is first prepared. Grip 26 of mandrel 20 is then gripped by the gripping component of an attaching tool (not shown). An end surface of the nosepiece 50 (FIGS. 8 and 9) of the attaching tool is caused to abut the end surface of polygonal portion 12b of rivet body 10. Blind rivet subassembly 1, gripped by the attaching tool, is inserted into the attaching holes of workpieces 41, 42 and into the thread hole 31 of nut 30, from the right side in FIG. 7, with mandrel head 23 going first, until the end surface of flange 12a of rivet body 10 abuts the surface around attaching hole 44 of workpiece 42.

It should be noted that the assembly method need not hold nut 30 by a holding component or be attached in advance to workpiece 41; it is also possible to insert the blind rivet subassembly 1 into attaching holes 43, 44 of workpieces 41, 42 first, and then attach nut 30 to rivet body 10, which at that point projects rearwardly (to the left in FIG. 7) from attaching hole 43 of workpiece 41.

The respective components of the assembly shown in FIG. 7 are so configured that a radial clearance gap is opened between the screw threads of female thread 32 of nut 30, and the sleeve 11 of rivet body 10.

FIG. 8 is a cross-sectional diagram which shows an intermediate step when fastening workpieces 41, 42 by means of blind rivet subassembly 1. Nut 30 is held in the position shown in FIG. 7. While holding an end surface of polygonal portion 12b of rivet head 12 of rivet body 10 with nosepiece 50 of the attaching tool, grip 26 of mandrel 20 remains gripped by the gripping component of the attaching tool, and is pulled out in the direction of arrow T1 in FIG. 8. Rivet body 10 is thus compressed in the axial direction by mandrel head 23 and undergoes plastic deformation so as to expand in diameter; this causes the deformed outer peripheral surface of the sleeve 11 of rivet body 10 to abut or engage female thread 32 of nut 30. Note that during this step, mandrel head 23 begins to forcibly enter an end 13 of the sleeve 11 of rivet body 10.

FIG. 9 is a cross-sectional diagram which shows a step when the fastening operation is further along, in which grip 26 of mandrel 20 has been pulled out farther, in the direction of arrow T2 (which is the same direction as arrow T1). Nosepiece 50 of the fastening tool holds the end surface of polygonal portion 12b. The sleeve 11 of rivet body 10 continues to undergo deformation so that its outer diameter is expanded into female thread 32 of nut 30. Also, mandrel head 23 simultaneously pushes against and widens the end 13 of the sleeve 11 of rivet body 10, and moves all of the way into the end 13 of sleeve 11 of rivet body 10, in turn causing rivet body 10 to undergo additional deformation, even in the direction in which mandrel 20 is pulled out, that is, arrow T2. The result is that a compressing force is applied to rivet body 10 in the axial direction, producing a fastening force.

Workpieces 41, 42 are thus clamped and secured between flange 12a of rivet body 10 and nut 30, the sleeve 11 of rivet body 10 having been deformed or mashed into securing engagement with female thread 32 of nut 30

FIG. 10 is a cross-sectional diagram showing the appearance when the fastening operation of the assembly shown in FIG. 9 is completed, with the gripping component of mandrel 20 pulled out farther and removed from the attaching tool. If rivet body 10 undergoes large plastic deformation, and rivet body 10 is work-hardened, further plastic deformation of the rivet body becomes difficult.

When the tensile stress of the mandrel 20 exceeds its breaking limit, mandrel 20 breaks at breaking portion 25, and the portion of the mandrel extending from the mandrel head 23 to the breaking portion 25 remains in the fastened portion of the rivet body 10. The portion of mandrel 20 which includes mandrel head 23 remains inside sleeve 11 of rivet body 10, and radially supports sleeve 11 from the inside. Sleeve 11 is still embedded in the female screw threads 32 of nut 30, and as a result, the force which fastens workpieces 41,42 between flange 12a and nut 30 is maintained, enabling the flange 12a and nut to be solidly fastened together. Nosepiece 50 is withdrawn in the rightward direction in FIG. 10, and the fastening process or method is completed.

According to the fastening structure of the present invention, thread hole 31 of nut 30 opens a gap with sleeve 11 before fastening, and, as a result, sleeve 11 can be simply inserted into thread hole 31 of nut 30 without being rotated.

During fastening, mandrel head 23 is pulled back into the end 13 of sleeve 11 of rivet body 10, and sleeve 11 expands in diameter and is embedded in the screw thread 32 of nut 30. Thereafter, sleeve 11 undergoes deformation in the axial direction as well, enabling a strong fastening force to be obtained.

In the fastening structure of the present invention, a strong fastening force is produced in the axial direction, and workpieces 41, 42 can thus be solidly fastened together.

In a conventional fastening method for blind rivets, the end of the sleeve of the rivet body is buckled, and the workpiece is fastened between the flange and the end of the buckled sleeve. There is a great amount of variability in the force required to cause buckling. In contrast, in the fastening structure of the present invention, after the end 13 of rivet body 10 has been pushed inwardly and widened, and is thereby embedded in female thread 32 of nut 30, sleeve 11 is further compressed by mandrel head 23, thus producing a stress or force; as a result, the fastening force can be controlled by the breaking stress or force of mandrel 20.

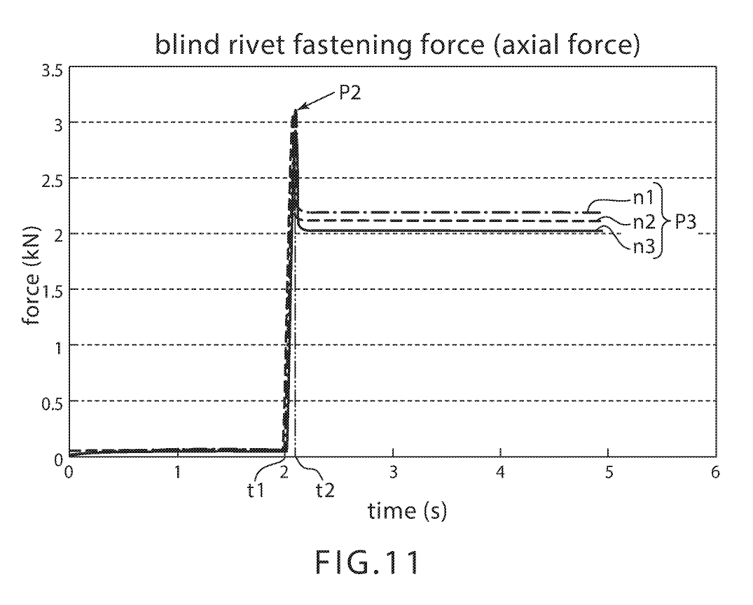

FIG. 11 is a diagram showing an example of the measurement of the relationship between time and force when a blind rivet is fastened by the methods of the present invention as shown in FIGS. 7-10. Measurements were taken on three samples n1-n3. When the extraction of mandrel 20 is carried out, the force begins to increase at time t1. When sleeve 11 begins to undergo deformation, the force increases abruptly, reaching a maximum force of P2 (approximately 3.15 kN) at time t2. When the mandrel breaks at breaking portion 25, the force decreases abruptly. After mandrel 20 breaks, the force P3 on samples n1-n3 lies in the range of from 2.0 to 2.2 kN and is maintained approximately uniformly.

After mandrel 20 breaks, the force is lowered somewhat from its maximum of P2, and the lower stress is maintained. This is the fastening force. The magnitude of the stress at the time mandrel 20 breaks is proportional to the fastening force (axial force). In the present invention, when the mandrel is pulled out and the sleeve 11 of the rivet body 10 has been expanded in diameter and embedded in the female thread 32 of the nut 30, the fastening force can be controlled by the breaking stress of the mandrel, since sleeve 11 is further compressed by mandrel head 23, producing an axial force. For this reason, by keeping the force when mandrel 20 breaks at a predetermined value, it is possible also to keep or maintain the fastening force after fastening at a value corresponding to the maximum force or stress.

By combining the blind rivet and the nut in the embodiment of the present invention, a workpiece can be fastened with a stabilized fastening force, by expanding the diameter of the sleeve and causing it to become embedded in the female thread of the nut.

It will be appreciated by persons skilled in the art that the above embodiments of the present invention have been described by way of example only, and not in any limitative sense, and that various alterations and modifications are possible without departure from the scope of the present invention as defined by the appended claims.

What is claimed is:

1. A fastening structure for fastening one or more workpieces defining respective axially-aligned attaching holes, comprising:
a blind rivet including a rivet body having a hollow sleeve having an inner diameter and an outer diameter and two ends, and a rivet head formed on one end of the hollow sleeve;
wherein the rivet body includes a sleeve side end and a rivet head side end, and having a length;
the rivet body further includes a through-hole coaxial with the hollow sleeve and extending from the sleeve side end to the rivet head side end; and further comprising:
a mandrel including an elongated shaft which is longer than the rivet body and having an outer diameter smaller than the inner diameter of the hollow sleeve;
wherein the mandrel further including a mandrel head having an outer diameter that is larger than the inner diameter of the hollow sleeve but smaller than the outer diameter of the hollow sleeve;
the mandrel head is disposed contiguous to the sleeve side end of the rivet body;
the mandrel shaft is disposed within the through-hole of the rivet body and projects axially outwardly from the rivet head side end of the rivet body; and further comprising:
a nut-shaped component operatively associated with the mandrel and the rivet body;
wherein the nut -shaped component defines a hole axially aligned with the hollow sleeve and having an inner diameter greater than the outer diameter of the hollow sleeve of the rivet body; and
wherein the nut-shaped component is disposed concentrically around both the sleeve side end of the hollow sleeve and the mandrel head.

2. The fastening structure claimed in claim 1, wherein:
the hole of the nut-shaped component includes an inner surface; and
wherein one of a set of female threads and a set of circumferential grooves is formed on the inner surface of the nut -shaped component.

3. The fastening structure claimed in claim 2, wherein:
the rivet head includes a flange having an outer diameter greater than the outer diameter of the hollow sleeve;
the flange is formed contiguous to the hollow sleeve proximate one end of the hollow sleeve; and
wherein the rivet head further includes a polygonal portion contiguous to the flange and is formed on an end of the rivet body disposed on the other side of the flange from said one end of the hollow sleeve.

4. The fastening structure claimed in claim 1, wherein:
the rivet head includes a flange having an outer diameter greater than the outer diameter of the hollow sleeve;
the flange is formed contiguous to the hollow sleeve proximate one end of the hollow sleeve; and
wherein the rivet head further includes a polygonal portion contiguous to the flange and is formed on an end of the rivet body disposed on the other side of the flange from said one end of the hollow sleeve.

5. The fastening structure claimed in claim 3, wherein the flange and the polygonal portion are formed as a one-piece unitary body.

6. The fastening structure claimed in claim 5, wherein the flange of the rivet body abuts one surface of a workpiece, and the nut-shaped component abuts another surface of the workpiece.

7. The fastening structure claimed in claim 5, wherein:
a plurality of workpieces abut one another so that their respective attaching holes are axially aligned; and
wherein the flange of the rivet body abuts a surface of one of the abutting workpieces, and the nut-shaped component abuts an opposite surface of another of the workpieces.

8. The fastening structure claimed in in claim 7, wherein:
the hollow sleeve, the rivet body through-hole, the flange, the nut-shaped component, and the mandrel are axially aligned with the attaching holes of the workpieces; and
wherein the other end of the hollow sleeve is deformed by the mandrel when a pulling force is exerted on the mandrel in a direction away from the abutting workpieces, so that the other end of the hollow sleeve is expanded in diameter into engagement with said one of the set of female threads and the set of circular grooves of the nut-shaped component by compression of the mandrel head axially against the hollow sleeve.

9. The fastening structure claimed in claim 8, wherein:
the mandrel includes a breakable portion which breaks when the pulling force exceeds a breaking point of the mandrel breakable portion; and
wherein, after the mandrel breaks at the breakable portion, a portion of the mandrel extending from the breakable portion to the mandrel head remains in the hollow sleeve.

10. The fastening structure claimed in claim 9, wherein:
when sufficient pulling force is exerted upon the mandrel in the direction opposite the abutting workpieces, the mandrel head is pulled inside the hollow sleeve;
the other end of the hollow sleeve is deformed to expand into the one of the set of female threads and the set of circular grooves of the nut-shaped component; and
wherein the workpieces are fastened between the flange and the nut-shaped component.

11. The fastening structure claimed in claim 9, wherein the mandrel breaking portion breaks when the pulling force equals or exceeds 3.15 kN.

12. A method for fastening multiple contiguous workpieces defining axially-aligned-holes by a blind rivet and a nut defining female internal threads, comprising:
forming a blind rivet by assembling a rivet body defining a through-hole to a mandrel so that a head of the mandrel is contiguous to a sleeve side end of the rivet body, and so that the mandrel passes through the rivet body through-hole and projects from the rivet head side end of the rivet body;
axially inserting the assembled blind rivet into the attaching holes of the workpieces from the rivet head side end, with the mandrel head going first, so that the axis of the blind rivet is coincident with the axis of the workpiece through-holes, until a flange of the rivet body abuts one of the contiguous workpieces;
disposing the nut over an outer periphery of the rivet head and an end of the rivet body sleeve proximate to the sleeve side end of the rivet body so that a surface of the nut abuts the surface of another of the contiguous workpieces and surrounds in the axial direction the axially-aligned attaching hole in said another of the contiguous workpieces; and
while supporting the rivet head, pulling the mandrel axially away from the contiguous workpieces so that the mandrel head enters the sleeve and compresses the end of the sleeve to expand an outer periphery of the sleeve into the female threads of the nut, to clamp the contiguous workpieces between the nut and the flange.
